(19) United States
(12) Patent Application Publication
(10) Pub. No.: US 2026/0111933 A1
(43) Pub. Date: Apr. 23, 2026

(54) INFORMATION PROVIDING APPARATUS, INFORMATION PROVIDING METHOD AND RECORDING MEDIUM

(71) Applicant: NEC Corporation, Tokyo (JP)

(72) Inventor: Yuri KAWAMOTO, Tokyo (JP)

(73) Assignee: NEC Corporation, Tokyo (JP)

(21) Appl. No.: 19/348,906

(22) Filed: Oct. 3, 2025

(30) Foreign Application Priority Data
Oct. 22, 2024 (JP) 2024-185775

(51) Int. Cl. G06Q 30/02; G06Q 30/0238

(52) U.S. Cl. CPC G06Q 30/0281; G06Q 30/0238

(57) ABSTRACT

An information providing apparatus according to the present disclosure includes at least one memory storing instructions; and at least one processor configured to execute the instructions to: recognize a store visit customer in a store; acquire information regarding a past store visit situation of the recognized store visit customer; determine a store visit message for the store visit customer, based on comparison between the past store visit situation and a current store visit situation; and output the determined store visit message.

This application is based upon and claims the benefit of priority from Japanese patent application No. 2024-185775, filed on October 22, 2024, the disclosure of which is incorporated herein in its entirety by reference.

### TECHNICAL FIELD

The present disclosure relates to an information providing apparatus or the like.

### BACKGROUND ART

It is important for a store such as retail stores or restaurants to build a good relationship with customers. In particular, by making an appropriate response to a regular customer, it is possible to enhance customer satisfaction and improve a repeat rate. Such a response often relies on memory ability and observation skills of an experienced salesclerk. For example, presence of a charismatic salesclerk who remembers a regular customer and appropriately talks to the regular customer enhances reputation of the store.

In addition, JP 2006-113819 A discloses a technology for providing advertisements according to customer attributes and their visiting type, that is, whether the customer visits the store individually or as part of a group.

### SUMMARY

One of objects of the present disclosure is to provide an information providing apparatus or the like that can provide a message according to a store visit situation to a store visit customer.

An information providing apparatus according to one aspect of the present disclosure includes at least one memory storing instructions, and at least one processor configured to execute the instructions to: recognize a store visit customer in a store, acquire information regarding a past store visit situation of the recognized store visit customer, determine a store visit message for the store visit customer, based on comparison between the past store visit situation and a current store visit situation, and output the determined store visit message.

An information providing method according to one aspect of the present disclosure includes recognizing a store visit customer in a store, acquiring information regarding a past store visit situation of the recognized store visit customer, determining a store visit message for the store visit customer, based on comparison between the past store visit situation and a current store visit situation, and outputting the determined store visit message.

A program according to one aspect of the present disclosure causes a computer to execute processing including recognizing a store visit customer in a store, acquiring information regarding a past store visit situation of the recognized store visit customer, determining a store visit message for the store visit customer, based on comparison between the past store visit situation and a current store visit situation, and outputting the determined store visit message. The program may be stored in a non-transitory computer-readable recording medium.

### BRIEF DESCRIPTION OF THE DRAWINGS

Exemplary features and advantages of the present disclosure will become apparent from the following detailed description when taken with the accompanying drawings in which:

FIG. 1 is an explanatory diagram illustrating a connection example between an information providing apparatus and another apparatus;

FIG. 2 is a block diagram illustrating a configuration example of the information providing apparatus;

FIG. 3 is a diagram illustrating an example of a display screen of a store visit message;

FIG. 4 is a diagram illustrating an example of the display screen of the store visit message;

FIG. 5 is a diagram illustrating an example of the display screen of the store visit message;

FIG. 6 is a flowchart illustrating an operation example of the information providing apparatus;

FIG. 7 is a diagram illustrating an example of the display screen of the store visit message; and

FIG. 8 is a block diagram illustrating an example of a hardware configuration of a computer.

### EXAMPLE EMBODIMENT

An information providing apparatus 100 according to the present disclosure can be used to output a message according to a store visit situation of a customer, to the customer who visits the store. The store visit situation is information indicating temporal characteristics and a store visit pattern regarding a store visit of the customer. For example, in a case where the customer visits the store at a frequency and in a time band same as usual, a message made by recognizing the consistency is provided. This positively reinforces customer’s habitual store visit behavior. In a case where the store visit frequency and the store visit time band of the customer have changed, the change is sensed, and an appropriate message is provided. As a result, a behavior pattern of each customer is grasped, and an individualized service is provided.

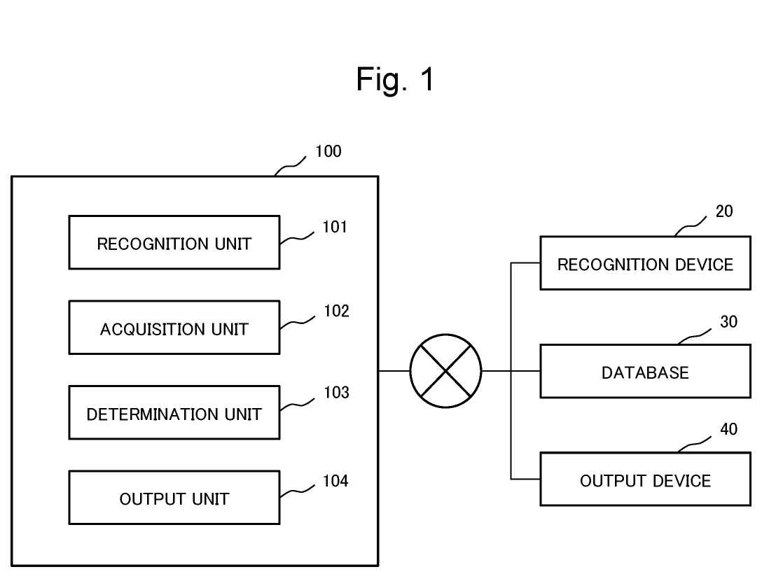

With reference to FIG. 1, a connection example between the information providing apparatus 100 and another apparatus according to the present disclosure will be described. The information providing apparatus 100 is communicably connected to, for example, a recognition device 20, a database 30, and an output device 40.

The recognition device 20 is a device that detects a store visit customer and identifies an individual. The recognition device 20 is installed at an entrance of a store, a main passage, around a cash register, or around a coffee machine. In a case where the customer performs a check-in operation to a store using a smartphone, it is sufficient to provide the recognition device 20 as necessary.

The database 30 stores a store visit history of the customer. The store visit history includes a store visit date and time. The database 30 may further store a purchase history of the customer. As the database 30, a database different for each type of data to be stored may be prepared.

The output device 40 outputs a store visit message to the store visit customer. The output device 40 is, for example, a display that displays a message. Specifically, for example, a smartphone of the customer, a display of a cash register cart, a store signage, a display of a coffee machine, a customer-facing display of a cash register, an information kiosk terminal, and the like function as the output device 40. The cash register cart is a shopping cart that includes a scanner and a tablet-type terminal in such a way that the customer can register a product while walking around the store. The output device 40 may be a speaker that outputs the store visit message by voice.

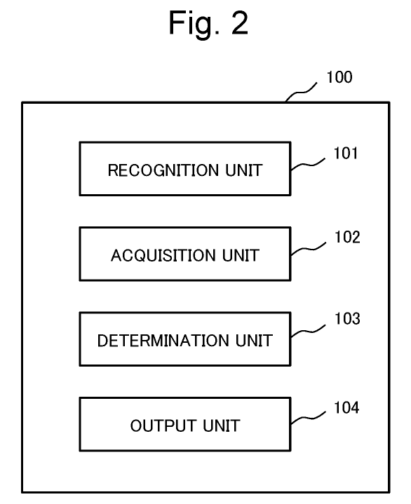

With reference to FIG. 2, a configuration example of the information providing apparatus 100 according to the present disclosure will be described. The information providing apparatus 100 according to one example embodiment includes a recognition unit 101, an acquisition unit 102, a determination unit 103, and an output unit 104.

The recognition unit 101 recognizes the store visit customer in the store. A method for recognizing the store visit customer is not particularly limited, and various methods including use of a smartphone application, reading of a member card, face authentication, or the like can be used to recognize the customer. The smartphone application is an interface that connects a customer and a store and may provide various functions other than the display of the store visit message. The functions provided by the smartphone application include, for example, a point card, electronic coupon delivery, product information and inventory check, provision of store information (opening hours, sale information, or the like), or the like. In a case where the smartphone application is used to recognize the customer, for example, the customer performs the check-in operation to the store by pressing a check-in button of the application or reads a two-dimensional code installed in the store. Thereafter, the smartphone application transmits information used to identify the customer to the information providing apparatus 100. The recognition unit 101 can recognize the store visit customer, from the received information. In addition, a method for recognizing the customer can be used for automatically detecting that the customer is in the store, using positional information of the smartphone, a beacon, a Near Field Communication technology, or the like.

There is a method for recognizing the store visit customer by reading a two-dimensional code or a code of a member card displayed on the smartphone, using the information kiosk terminal of the store. The information kiosk terminal is used to give a store visit point to the customer, for example.

In a case where face authentication is used, there is a method for recognizing the customer using a camera installed at the entrance of the store or a sales floor. In addition, there is a case where the cash register or the coffee machine recognizes the customer. For example, the customer can be identified by using face authentication, the membership card, the code of the smartphone application, a code of a personal identifiable coupon, or the like.

A method is also considered for recognizing the customer near the coffee machine, by identifying the customer by performing face authentication or reading the code with the cash register and determining whether the customer near the coffee machine is the same as the customer who has made payment at the cash register. For example, a customer after payment is recognized at the time of using the coffee machine, by printing a receipt including a code, from which a checkout number can be identified, using the cash register and holding the code over a reader of the coffee machine. A method can be used for tracking a customer after payment using a camera and recognizing the customer who uses the coffee machine within a predetermined time after payment of a product using the coffee machine.

The acquisition unit 102 acquires information regarding a past store visit situation of the store visit customer recognized in the store. Hereinafter, it is described that the acquisition unit 102 acquires information regarding a past store visit interval or a past store visit time of the store visit customer, as the information regarding the past store visit situation. The information regarding the past store visit interval or the past store visit time indicates a normal store visit interval or a normal store visit time or a tendency of a store visit interval or a store visit time of the customer. The information is acquired, for example, by referring to the store visit history recorded in the database 30. The acquisition unit 102 analyzes the store visit history and acquires the information regarding the past store visit situation that is an analysis result. The analysis result may be stored in the database 30 and periodically updated. The acquisition unit 102 may acquire the information regarding the past store visit situation, analyzed by another apparatus and stored in the database 30.

The past store visit interval can be calculated as an average value of a plurality of recent store visit intervals. For example, in a case where latest 5 times of visit of a certain customer are every seven days, the store visit interval of the customer is calculated as 7 days. A statistical value such as a standard deviation can be acquired, in consideration of variations of the store visit intervals. The information regarding the past store visit interval may be a specific numerical value (for example, once a week) or the like. The information regarding the store visit interval acquired by the acquisition unit 102 may be information classified into categories such as “regular customer”, “ordinary customer”, “rare store visit customer”, or the like. For example, a customer who visits the store three or more times a week is classified as “regular customer”, a customer who visits the store twice or 3 times a month is classified as “ordinary customer”, and a customer with a frequency equal to or less than that is classified as “rare store visit customer”. The acquisition unit 102 may acquire the information regarding the store visit interval, by confirming the category recorded in the database 30. The classification of the category may be adjusted depending on a type or a business form of the store.

The information regarding the past store visit time is obtained by analyzing a tendency of the plurality of latest store visit times. The acquisition unit 102 divides 24 hours by predetermined time such as 1 hour and counts the number of times of store visits in each time band. As a result, a time band when the customer visits the store most frequently or a time band when the customer conversely visits the store less frequently can be specified. The acquisition unit 102 may analyze whether a store visit pattern is different between the days of the week or between weekdays and holidays. The acquisition unit 102 may calculate an average and a standard deviation of the store visit time on each day of the week. For example, in a case where a certain customer tends to visit the store between 18:00 and 19:00 on weekdays and visit the store between 13:00 and 15:00 on holidays, the acquisition unit 102 acquires such a store visit pattern for each time band, as information.

The determination unit 103 determines a store visit message for the store visit customer, based on comparison between a past store visit situation and a current store visit situation of the store visit customer recognized in the store. Hereinafter, a case will be described where the current store visit situation is specifically a current store visit interval or a current store visit time. The current store visit interval is, for example, a length of a period from a previous store visit to a current store visit. The determination unit 103 determines the store visit message for the store visit customer, based on comparison between the past store visit interval and an interval from the previous store visit or comparison between the information regarding the past store visit time and a current time.

For example, in a case where the store visit interval is about the same as an average in the past, a message such as “Thank you for coming to our store as usual” is determined. On the other hand, in a case where the store visit interval is shorter than usual, a message such as “We appreciate that you visit our store more frequently” or “This is your second visit in this week. Are you looking for something different from usual?” is selected. Conversely, in a case where the store visit interval is longer than usual, a message such as “Long time no see. How have you been?” is determined.

Regarding the store visit time, in a case where the customer visits the store in a usual time band, a message such as “Thank you for coming at your usual time” is selected. In a case where the store visit time of the customer is within 1 hour before and after the past store visit time, it can be regarded that the customer visits the store in the usual time band. In a case of a store visit in a time band different from usual, a message is determined such as “You come earlier today” or “It is unusual for you to visit the store at night”, in which a change in the time band is recognized. The time band different from usual is, for example, a case where the store visit time is different from an average store visit time by two or more hours. In a case where the current store visit time is different from an average store visit time on the same day of the week in the past by twice or more of the standard deviation, the determination unit 103 may determine that the store visit time is different from the usual visit time.

The determination unit 103 may determine a message based on a store visit frequency, for a customer whose store visit time is not particularly determined.

When determining these messages, for example, the determination unit 103 generates the message using a template prepared in advance. As the template, a plurality of patterns in accordance with a change in the store visit interval or the time is prepared, and a pattern most suitable for the current store visit situation is selected. A more personalized message is generated, by inserting a variable such as a customer name or specific time information into the template. For example, a customer name can be directly incorporated into a message, such as “Mr./Ms. ○○, thank you for your evening visit as usual”.

The determination unit 103 may generate a more flexible and natural message, using a natural language processing technology such as a large language model. In this case, the store visit situation and customer information are used as inputs into the model, and an appropriate message is generated. The generated message is determined as a final message, through post processing such as filtering of inappropriate expression or length adjustment. The template-based generation and the generation using the natural language processing technology can be combined.

Moreover, the determination unit 103 may adjust the message determined according to a store visit frequency of the store visit customer. For example, a more intimate message is selected for the regular customer, and a message having content that urges the customer to visit the store again is determined for the rare store visit customer. The determination unit 103 may determine a personalized message, for the regular customer. Then, for the customer with the low frequency, the message is not determined, or a general message that is not personalized is determined.

In this way, the determination unit 103 analyzes the past store visit pattern and the current store visit situation of the store visit customer in detail and determines a message optimized for each customer. As a result, it is possible to achieve fine and effective communication for each customer.

The output unit 104 outputs the store visit message determined by the determination unit 103. For example, the output unit 104 transmits the store visit message to the output device 40. For example, the output device 40 may have various forms such as a smartphone of a customer, a signage in a store, an information kiosk terminal, a display of a coffee machine, or a customer-facing display of a cash register.

The output message is mainly displayed on a screen. For example, in a case where the store visit message is displayed through the smartphone application, it is possible to send a notification to the customer using a push notification function. On the other hand, the signage in the store and the display of the coffee machine display the store visit message as a text. Depending on a situation, the message may be output as voice. In the interest of privacy, it is sufficient for a speaker of the output device 40 to output voice with a small volume.

The output unit 104 may output the message on the customer-facing display of the cash register in such a way as to display the message during payment processing. The output unit 104 may output the message on the coffee machine, for a customer who has purchased a product using the coffee machine at the cash register. There is a possibility that a customer who has purchased coffee slowly reads the message, using a coffee brewing time. Therefore, the output unit 104 may adjust a display time, in such a way that a display time of the message on the coffee machine is longer than that of the other output device 40. At this time, the determination unit 103 may determine a longer message, for the customer who uses the coffee machine. For example, in a case of the display on the coffee machine, the determination unit 103 generates a more detailed message including additional information such as a type of coffee preferred by the customer or recommendation according to the weather of the day.

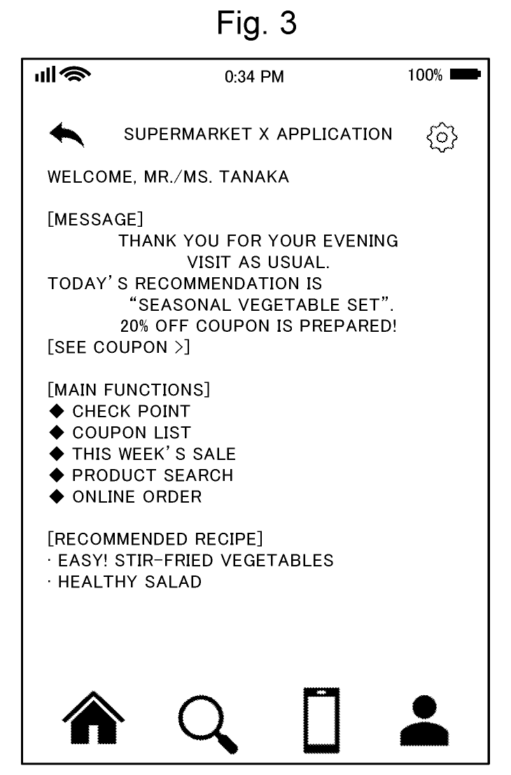

A display example of the store visit message on a smartphone application screen will be described, with reference to FIG. 3. The screen illustrated in FIG. 3 includes elements including a header, a customer name display, a message box, a link to a coupon, an access to main functions, a recommended recipe, and a footer menu. In a header portion, an application name “supermarket X application” and a setting icon are displayed. In the customer name, greetings to an individual customer “Welcome, Mr./Ms. Tanaka” are displayed. A store visit message is displayed in the message box. For example, a personalized message “Thank you for your evening visit as usual. Today’s recommendation is “seasonal vegetable set”. A 20% off coupon is prepared for you!” is displayed. On the screen, a button for accessing the coupon mentioned in the message is provided.

The displayed store visit message is dynamically changed according to the store visit situation of the customer. A customer engagement can be enhanced by the message cooperating with a related function (coupon, recommended product, or the like). For example, in the example in FIG. 3, a usual store visit time band (evening) of the customer is recognized, and a message based on that is displayed. Moreover, by combining the recommended product and the coupon, a customer’s buying intention is stimulated. Proposal of the recommended recipe enhances usefulness of the application, by providing information useful for daily life of the customer.

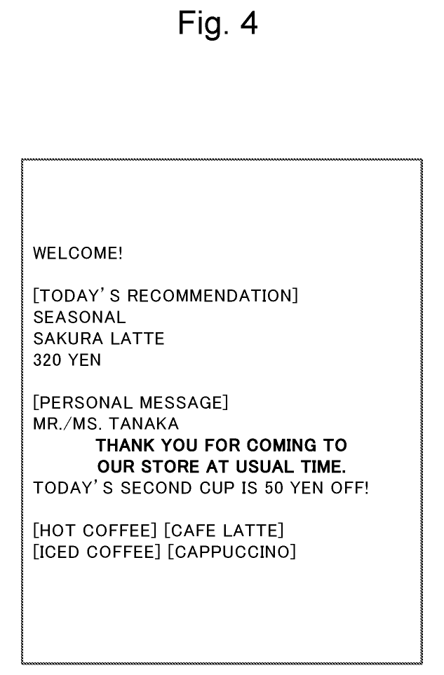

A display example of the store visit message on the display of the coffee machine will be described with reference to FIG. 4. A screen in FIG. 4 includes a personalized store visit message as “Mr./Ms. Tanaka, thank you for coming to our store at usual time. We will discount 50 yen for your second cup today!”. The screen includes information regarding the recommended product “seasonal Sakura latte 320 yen”. Moreover, the customer can select a product from the screen.

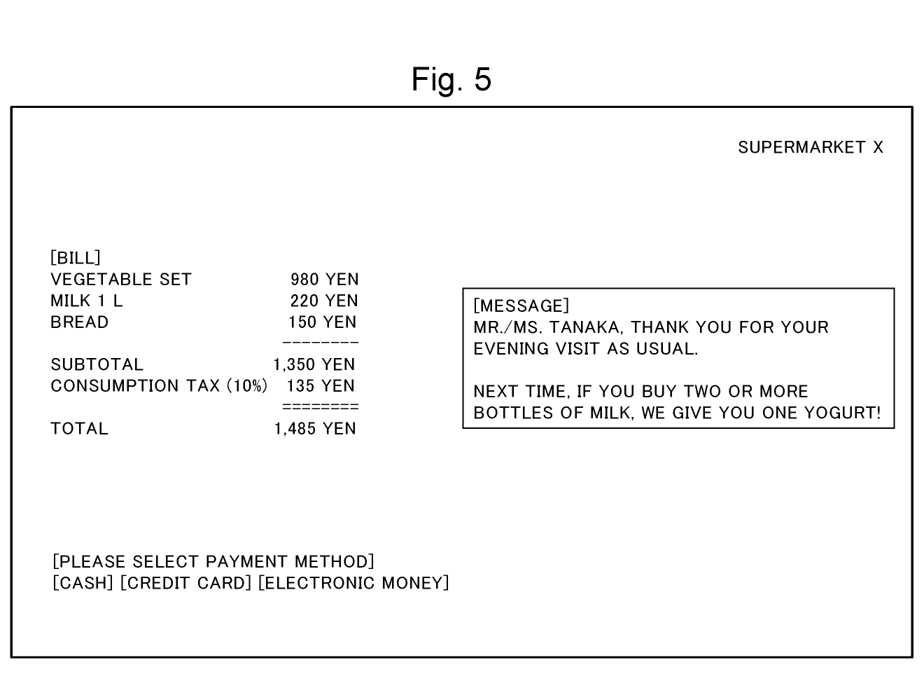

A display example of the store visit message on the customer-facing display of the cash register will be described with reference to FIG. 5. On a left side of the center of the screen, accounting information such as a product purchased by the customer, its price, or a total amount is displayed. On a right side of the center of the screen, an individualized store visit message “Mr./Ms. Tanaka, thank you for your evening visit as usual. Next time, if you buy two or more bottles of milk, we give you one yogurt!” is displayed. On a lower side of the screen, options of a payment method are displayed. In this display example, by displaying the individualized message simultaneously with the payment processing, efficient information provision and promotion of next store visit are facilitated.

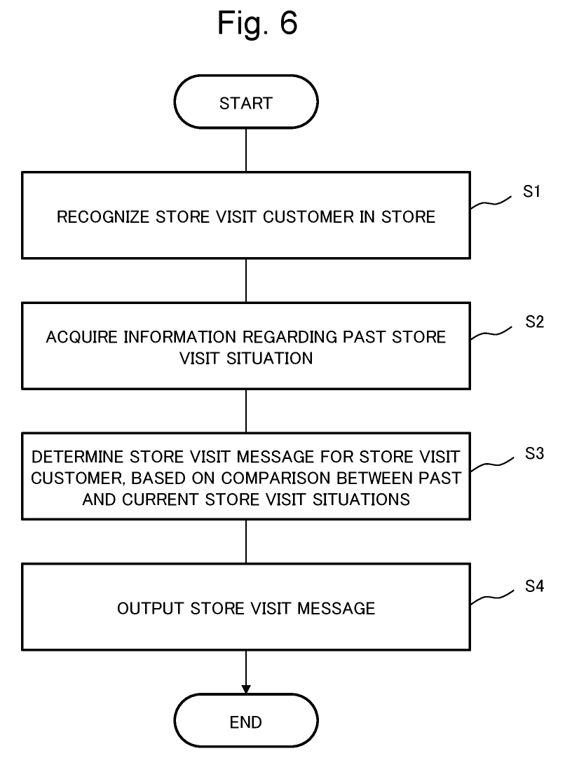

An operation example of the information providing apparatus 100 according to the present disclosure will be described, with reference to FIG. 6. Processing in FIG. 6 is started, for example, in a case where a sensor or a camera at the entrance of the store detects a customer. In addition, the processing in FIG. 6 may be started in response to an event such as detection of a beacon in the store by a smartphone application of the customer or a check-in operation by the customer using a store application.

In step S1, the recognition unit 101 recognizes a store visit customer in a store. In step S2, the acquisition unit 102 acquires information regarding the past store visit interval or the past store visit time of the store visit customer recognized in the store. In step S3, the determination unit 103 compares the information regarding the past store visit interval or the past store visit time acquired by the acquisition unit 102 with the current store visit situation and determines a store visit message for the store visit customer. In step S4, the store visit message determined by the determination unit 103 is output. An output destination is, for example, the smartphone application of the customer, the digital signage in the store, or the like. As described above, the information providing apparatus 100 ends the processing in FIG. 6.

Depending on a type of a store or individuality of a customer, there are many customers who do not like to be spoken by a person. On the other hand, an importance of maintaining a good relationship with the customer does not change. Therefore, while maintaining good points such as flexibility of human response or personalization ability, use of a technology for achieving efficient customer support would be desirable.

According to the example embodiment, in the information providing apparatus 100, the determination unit 103 can determine the message optimized for each customer, by identifying each customer by the recognition unit 101 and acquiring the past store visit situation by the acquisition unit 102. As a result, the message according to the store visit situation can be provided to the store visit customer. Personalized and warm communication can be performed for each customer, and this improves customer satisfaction and enhances loyalty.

It is possible to provide information in accordance with the current situation of the customer, by detecting a real-time store visit of the customer by the recognition unit 101 and determining a message for the customer who is visiting the store, by the determination unit 103. It is possible to detect the change in the store visit pattern of the customer and to make an appropriate response, by analyzing the past store visit interval or store visit time by the acquisition unit 102 and comparing the past store visit interval or store visit time with the current store visit situation by the determination unit 103. For example, by sending a message of gratitude to a customer whose store visit frequency increases, the behavior can be enhanced, and more store visits can be promoted. Moreover, communication with the customer can be achieved without using human resources, by outputting a message with various types of means including the smartphone of the customer, the digital signage, or the like by the output unit 104. As a result, a store staff can concentrate on other works, and efficiency of store management is improved.

The example embodiment described above can be variously modified. Modifications will be described below.

### [First Modification]

The determination unit 103 may determine the store visit message, based on the purchase history of the store visit customer. Specifically, the determination unit 103 may customize a message to be generated, utilizing the purchase history of the customer. For example, a message based on past purchase content such as “Mr./Ms. Tanaka, how was the product you have purchased?” or “The coffee you always purchase is on sale today” is determined.

The determination unit 103 can change a method for utilizing the purchase history according to the store visit frequency. In a case of a customer with a lower store visit frequency, there is a possibility that information regarding a past purchase history has become old. Therefore, a message in consideration of recent general trends, seasonal products, or the like is generated. On the other hand, for a customer with a higher store visit frequency, individualized recommendation information is provided, utilizing a more recent purchase history.

Moreover, the determination unit 103 may determine the store visit message, using information regarding a purchased product on the store visit day. For example, a message including recommendation of related products or sale information is determined, based on information regarding a product that the customer puts in a basket or a product for which payment has been completed. In a case where an unusual amount or type of the product is purchased, a message that mentions the change and indicates expression of gratitude with more politeness is generated. For example, a message such as “Thank you for your purchasing more products. We prepare a special coupon for you that you can use next time” is determined. The determination unit 103 may specify a product that has purchased by the customer in a plurality of past store visits, and in a case where the customer does not purchase that product on that day, the determination unit 103 may generate a message such as “Mr./Ms. ○○, how about XXX that you have always bought?”.

For various output devices 40, the determination unit 103 may determine a message according to characteristics of each output device 40. For example, the determination unit 103 determines a message linked with product selection, as the message output to the coffee machine. The determination unit 103 determines a message linked with purchase information, as the message output to the cash register. This makes it possible to effectively utilize opportunities of communication with the customer.

The determination unit 103 may determine a message based on a product that the customer looks at in the store or an advertisement of interest. Information regarding the product that the customer looks at in the store or the advertisement is acquired using a position of the customer in the store or a line-of-sight tracking technology. For example, in a case where the customer is stopping in front of a specific product shelf, a message such as “What product are you looking for? This product is this week’s recommendation” is generated, and timely information is provided.

According to these modifications, it is possible to provide a more individualized and appropriate message according to the situation, and it is expected to improve the customer satisfaction and promote the buying intention

### [Second Modification]

In the present modification, a response in a case where a plurality of customers exists in the store will be described. In particular, consideration in a case where a large display such as a store signage that can be simultaneously viewed by a plurality of customers is used will be described.

In a case where the store visit message is output to the store signage, it is necessary to effectively provide information, while considering personal privacy. Therefore, in a case where the recognition unit 101 recognizes the plurality of customers in the store, the determination unit 103 may determine a common store visit message for the plurality of store visit customers. Here, the plurality of store visit customers indicates two or more customers, and a specific threshold can be appropriately set according to a size or a situation of the store.

For example, the determination unit 103 analyzes a tendency of store visit time bands of the customers currently in the store and determines a message according to a time band of the most customers. Specifically, in a case where more customers visit the store in a normal time band, as compared with a normal store visit time band of each of the plurality of customers, a message such as “Thank you all for coming to our store today in this time band” is generated. A message indicating an overall tendency such as “More people are coming later than usual today” or “More people are coming earlier than usual” can be determined. Regarding the store visit interval, similarly, in a case where a ratio of customers whose store visit interval is shorter than usual is higher than a standard, a message such as “Today, it seems many people come to our store more frequently than usual. Do you have anything special?” is generated. For example, in a case where 50% or more of the customers in the store have a store visit interval shorter than usual by 30% or more, it is possible to provide a criterion for recognizing that the store visit interval is shortened.

Moreover, the determination unit 103 can perform weighting according to the store visit frequency and adjust content of the message. For example, in a time band when there are many regular customers, a message such as “Thank you for always choosing us. We have prepared our today’s special service” is determined.

The output unit 104 displays these common messages on the signage. Since the signage is usually installed at a conspicuous position in the store, there is a high possibility that the signage is viewed by more customers than a personal device such as a smartphone. Therefore, it is possible to effectively transmit information to more customers.

On the other hand, in a case where there is only one store visit customer in the store, the output unit 104 can display a more personalized message on the signage. In this case, the determination unit 103 determines a message with reference to information regarding a purchase history, an attribute, or the like, in addition to the store visit interval and the store visit time band of the customer.

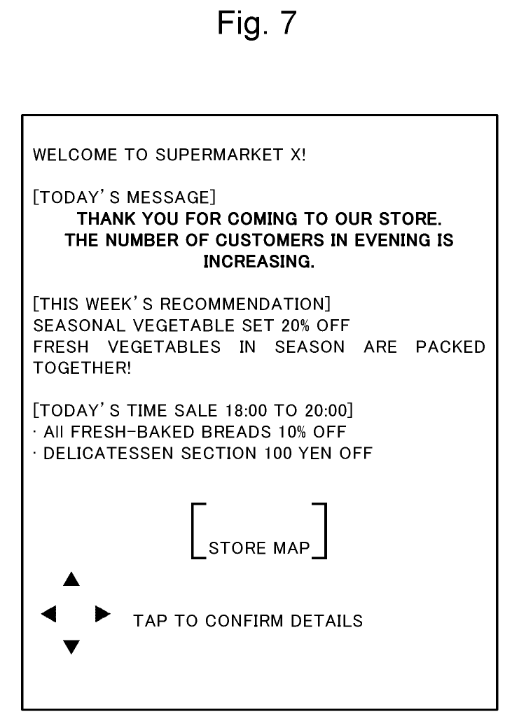

A display example of the store visit message on the store signage will be described, with reference to FIG. 7. This display example assumes a case where a plurality of customers exists in the store. The store signage may be a signage that has an interactive function for receiving an operation by a customer. In FIG. 7, as [Today’s message], a general message according to a time band is displayed such as “Thank you for coming to our store. The number of customers in the evening has been increasing”. This tells a current store situation, without identifying an individual customer.

The output unit 104 can change the output destination of the message, depending on whether a plurality of store visit customers is in a predetermined area in the store. Here, the predetermined area indicates a range where content output to the output device 40 can be confirmed. For example, in a case where the entire store is set as the predetermined area and two or more store visit customers are in the store, the output unit 104 outputs the store visit message to only the signage. In a case where the number of store visit customers in the store is one, the output unit 104 can perform control for outputting the store visit message to a smartphone of an individual.

The determination unit 103 may determine a message, according to the number of customers or population density in the store. By generating a simple message at the time of congestion and shortening a display time, it is possible to increase a turnover ratio of the customers. Conversely, in a case where the store is empty, it is possible to generate a message that indicates more detailed product information or prompts longer stay. In addition, by adjusting the store visit message according to the congestion status, it is possible to optimize a traffic line of the customer and contribute to relieving the congestion in the store. For example, in a case where a specific area is congested, it is possible to generate a message for refraining from guiding to that area or to delay output of the message until the congestion is relieved. In this way, by adjusting the message in consideration of the congestion status, it is possible to improve the customer satisfaction and to efficiently manage the store.

In this way, by effectively providing the information while considering the privacy, even under the situation where the plurality of customers exists, it is possible to improve the customer satisfaction and activate the store.

### [Third Modification]

The information providing apparatus 100 according to the present disclosure is applicable to various retail stores such as shopping malls, apparel shops, home appliance stores, or home centers, as well as convenience stores and supermarkets. By adjusting definition of the store visit frequency or the purchase pattern, according to the characteristics of each business type, a more messaging strategy can be achieved. The definition of the store visit frequency can be flexibly set according to characteristics or a customer segment of the store. For example, adjustment in accordance with the business type can be performed, such as defining the store visit frequency on a weekly basis for a store that handles daily necessities and defining the store visit frequency on a monthly basis for the apparel shops. Definition of the “regular customer” can be set by combining a plurality of elements such as the number of times of store visits or a purchase amount.

### [Hardware Configuration]

In the above-described example embodiments, each component of the information providing apparatus 100 represents a block of functional units. A part or all of the components of the information providing apparatus 100 may be achieved by any combination of a computer 500 and a program.

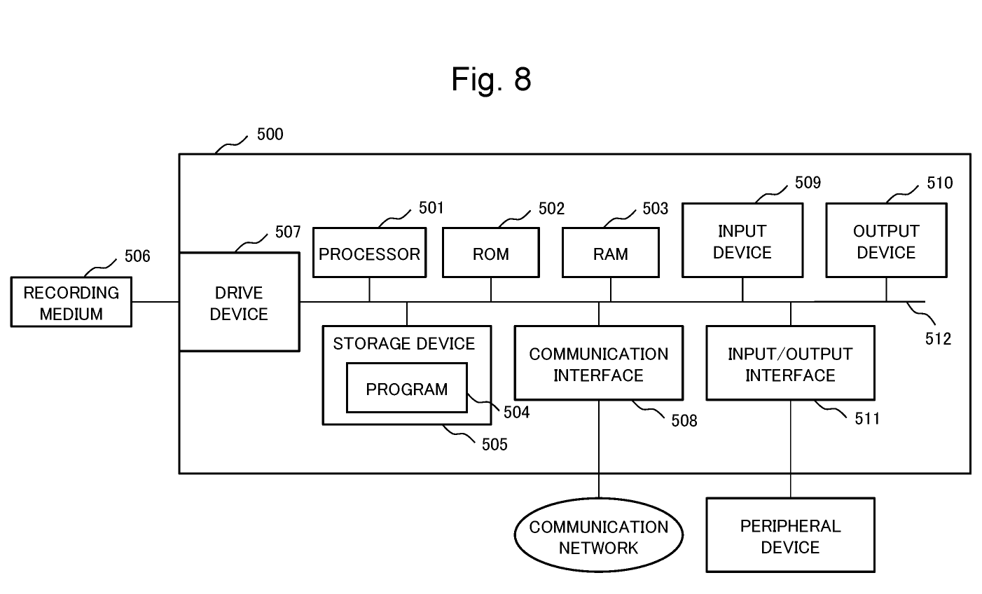

FIG. 8 is a block diagram illustrating an example of a hardware configuration of the computer 500. Referring to FIG. 8, the computer 500 includes, for example, a processor 501, a read only memory (ROM) 502, a random access memory (RAM) 503, a program 504, a storage device 505, a drive device 507, a communication interface 508, an input device 509, an output device 510, an input/output interface 511, and a bus 512.

The processor 501 controls the entire computer 500. Examples of the processor 501 include a central processing unit (CPU) and the like. The number of processors 501 is not particularly limited, and the number of processors 501 is one or more.

The program 504 includes an instruction for achieving each function of the information providing apparatus 100. The program 504 is stored in advance in the ROM 502, the RAM 503, and the storage device 505. The processor 501 achieves each function of the information providing apparatus 100 by executing the instructions included in the program 504. The RAM 503 may store data to be processed in each function of the information providing apparatus 100.

The drive device 507 reads and writes a recording medium 506. The communication interface 508 provides an interface with a communication network. The input device 509 is, for example, a mouse, a keyboard, or the like, and receives an input of information from an administrator or the like. The output device 510 is, for example, a display, and outputs (displays) information to the administrator or the like. The input/output interface 511 provides an interface with a peripheral device. The bus 512 connects the components of the hardware. The program 504 may be supplied to the processor 501 via the communication network, or may be stored in advance in the recording medium 506, and the drive device 507 may read the program and supply the program to the processor 501.

The hardware configuration illustrated in FIG. 8 is an example, and other components may be added or some components may not be included.

There are various modifications of the method for achieving the information providing apparatus 100. For example, the information providing apparatus 100 may be achieved by any combination of a computer and a program different for each component. A plurality of components included in the information providing apparatus 100 may be achieved by any combination of one computer and a program.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. The configurations in the example embodiments can be combined with each other without departing from the scope of the present disclosure.

Some or all of the above example embodiments may be described as the following Supplementary Notes, but are not limited to the following.

### [Supplementary Note 1]

An information providing apparatus including:

recognition means for recognizing a store visit customer in a store;

acquisition means for acquiring information regarding a past store visit situation of the recognized store visit customer;

determination means for determining a store visit message for the store visit customer, based on comparison between the past store visit situation and a current store visit situation; and

output means for outputting the determined store visit message.

### [Supplementary Note 2]

The information providing apparatus according to supplementary note 1, in which

the determination means determines the store visit message, based on a change between past and current store visit intervals or a change between past and current store visit times.

### [Supplementary Note 3]

The information providing apparatus according to supplementary note 1 or 2, in which

the determination means further determines the store visit message, based on a purchase history of the store visit customer.

### [Supplementary Note 4]

The information providing apparatus according to any one of supplementary notes 1 to 3, in which

the determination means further determines the store visit message, according to a store visit frequency of the store visit customer.

### [Supplementary Note 5]

The information providing apparatus according to any one of supplementary notes 1 to 4, in which

the output means outputs the store visit message, to any one of a portable terminal of the store visit customer, an information kiosk terminal, a display of a coffee machine, or a customer-facing display of a cash register.

### [Supplementary Note 6]

The information providing apparatus according to any one of supplementary notes 1 to 5, in which

the output means outputs the store visit message to a signage in the store.

### [Supplementary Note 7]

The information providing apparatus according to supplementary note 6, in which

in a case where there is a plurality of store visit customers in a predetermined area of the store, the determination means determines the common store visit message for the plurality of store visit customers.

### [Supplementary Note 8]

The information providing apparatus according to any one of supplementary notes 1 to 7, in which

the output means changes an output destination of the store visit message, according to whether there is the plurality of store visit customers in the predetermined area of the store.

### [Supplementary Note 9]

An information providing method including:

recognizing a store visit customer in a store;

acquiring information regarding a past store visit situation of the recognized store visit customer;

determining a store visit message for the store visit customer, based on comparison between the past store visit situation and a current store visit situation; and

outputting the determined store visit message.

### [Supplementary Note 10]

A program for causing a computer to execute processing including:

recognizing a store visit customer in a store;

acquiring information regarding a past store visit situation of the recognized store visit customer;

determining a store visit message for the store visit customer, based on comparison between the past store visit situation and a current store visit situation; and

outputting the determined store visit message.

Some or all of the configurations described in Supplementary Notes 2 to 8 dependent on the above-described Supplementary Note 1 can also be dependent on Supplementary Notes 9 and 10 by the dependency relationship similar to that of Supplementary Notes 2 to 8. Some or all of the configurations described as the Supplementary Notes can be similarly dependent on not only the Supplementary Notes 1, and 9 and 10, but also various pieces of hardware and software, and various recording devices or systems for recording software without departing from the above-described example embodiments.

1. An information providing apparatus comprising:
at least one memory storing instructions; and
at least one processor configured to execute the instructions to:
recognize a store visit customer in a store;
acquire information regarding a past store visit situation of the recognized store visit customer;
determine a store visit message for the store visit customer, based on comparison between the past store visit situation and a current store visit situation; and
output the determined store visit message.

2. The information providing apparatus according to claim 1, wherein the at least one processor is further configured to execute the instructions to:
determine the store visit message, based on a change between past and current store visit intervals or a change between past and current store visit times.

3. The information providing apparatus according to claim 1, wherein the at least one processor is further configured to execute the instructions to:
determine the store visit message, based on a purchase history of the store visit customer.

4. The information providing apparatus according to claim 1, wherein the at least one processor is further configured to execute the instructions to:
determine the store visit message, according to a store visit frequency of the store visit customer.

5. The information providing apparatus according to claim 1, wherein the at least one processor is further configured to execute the instructions to:
output the store visit message, to any one of a portable terminal of the store visit customer, an information kiosk terminal, a display of a coffee machine, or a customer-facing display of a cash register.

6. The information providing apparatus according to claim 1, wherein the at least one processor is further configured to execute the instructions to:
output the store visit message to a signage in the store.

7. The information providing apparatus according to claim 6, wherein the at least one processor is further configured to execute the instructions to:
in a case where there is a plurality of store visit customers in a predetermined area of the store, determine the common store visit message for the plurality of store visit customers.

8. The information providing apparatus according to claim 1, wherein the at least one processor is further configured to execute the instructions to:
change an output destination of the store visit message, according to whether there is a plurality of store visit customers in a predetermined area of the store.

9. An information providing method comprising:
recognizing a store visit customer in a store;
acquiring information regarding a past store visit situation of the recognized store visit customer;
determining a store visit message for the store visit customer, based on comparison between the past store visit situation and a current store visit situation; and
outputting the determined store visit message.

10. A non-transitory computer-readable recording medium storing a program for causing a computer to execute processing comprising:
recognizing a store visit customer in a store;
acquiring information regarding a past store visit situation of the recognized store visit customer;
determining a store visit message for the store visit customer, based on comparison between the past store visit situation and a current store visit situation; and
outputting the determined store visit message.
